(19) United States
(12) Patent Application Publication
(10) Pub. No.: US 2016/0041632 A1
(43) Pub. Date: Feb. 11, 2016

(54) CONTACT DETECTION SYSTEM, INFORMATION PROCESSING METHOD, AND INFORMATION PROCESSING APPARATUS

(71) Applicants: Yasuhiro ONO, Kanagawa (JP); Yohei KATOH, Kanagawa (JP)

(72) Inventors: Yasuhiro ONO, Kanagawa (JP); Yohei KATOH, Kanagawa (JP)

(73) Assignee: RICOH COMPANY, LTD., Tokyo (JP)

(21) Appl. No.: 14/801,125

(22) Filed: Jul. 16, 2015

(30) Foreign Application Priority Data
Aug. 6, 2014 (JP) 2014-160041
Feb. 9, 2015 (JP) 2015-023021

(51) Int. Cl. G06F 3/0354; H04N 5/225; G06F 3/042

(52) U.S. Cl. CPC G06F 3/03542; G06F 3/0421; G06F 3/0425; G06F 3/0428; H04N 5/2257

(57) ABSTRACT

A contact detection system includes a display, an object detection unit disposed at periphery of the display to detect a contact of an object on the display, a device detector to detect a first light emitted from an input device to detect a contact of the input device on the display, and an information processing apparatus. The object detection unit includes a light source to emit a second light to an object. The device detector includes an image capturing device to capture an image using the first light or the second light. The information processing apparatus includes an image acquisition unit to acquire a captured image, and a control unit to control the light source to turn off the second light when a luminance-increased area exists in the captured mage, and to control the device detector to be ready to detect a contact of the input device to the display.

This application claims priority pursuant to 35 U.S.C. §119(a) to Japanese Patent Application Nos. 2014-160041, filed on Aug. 6, 2014 and 2015-023021, filed on Feb. 9, 2015 in the Japan Patent Office, the disclosure of which are incorporated by reference herein in their entirety.

### BACKGROUND

1. Technical Field

The present invention relates to a contact detection system, an information processing method, and an information processing apparatus.

2. Background Art

Electronic information boards such as electronic white boards used for meetings include optical touch sensors that can detect positions of pen-like devices on displays by detecting light emitted from the pen-like devices. Users can input information electronically to the electronic information boards by operating the pen-like devices on the displays.

Electronic information boards can employ an optical touch panel disposed with two camera modules at the upper-left corner and the upper-right corner of a display, wherein each module includes an image sensor and a lens. The camera module is used to obtain a position of the pen-like device such as a light emission device. Then, two dimensional coordinates of the light emission device on a detection face is calculated by using the triangulation method.

Further, instead of using the light emission device, an optical touch panel can be disposed with a camera module to capture images above a surface of a display, in which a light unit (e.g., infrared light emission unit) is disposed near the camera module to scan an object existing on or over a surface of the display, and a retrorefector disposed at the periphery of the display, in which reflection light reflected from the retrorefector is captured by the camera module, which is known as light-blocking method that calculates a position of the object based on the reflection light having a light-blocked area.

The camera module can employ any devices that can detect light as a face image or a linear image such as a complementary metal oxide semiconductor (CMOS) image sensor and a charge coupled device (CCD) image sensor that can capture images two-dimensionally, a linear image sensor that can capture one dimensional image, and a position detection device known as the position sensitive detector (PSD).

The electronic information board has a palm rejection function that can write information on the display while a hand contacts on the display. As to this electronic information board, fingers of users and a light-emission pen (hereinafter, light pen) can be detected. The electronic information board includes the light pen having a pointing end that emits light, and a retrorefector that reflects light, and the electronic information board controls the reflection-ON/OFF of the retrorefector.

As to the palm rejection, when a user writes information by using the light pen, peripheral lighting is turned off to detect and track positions of the light pen (hereinafter, pen detection mode), wherein the peripheral lighting is used to detect an object based on reflection light reflected from the retrorefector. When the user does not use the light pen, the peripheral lighting is turned on to detect and track positions of a finger (hereinafter, finger detection mode). The pen detection mode and finger detection mode can be switched as required. Further, the optical touch sensor switches the operation modes between the pen detection mode and the finger detection mode each time the user writes information.

An optical touch sensor can detect the existence of the light pen as follows. For example, a light pen includes a contact detection sensor to detect a touching and untouching of the light pen on the detection face, and a wireless transmitter to report the touching and untouching of the light pen to a controller of the optical touch sensor wirelessly.

Conventionally, the controller of the optical touch sensor employs two operation modes such as a finger detection mode to detect and track a finger, and a pen detection mode to detect and track a light pen to draw an image on the display by hand writing, in which a transition from the finger detection mode to the pen detection mode is triggered by a reception of a touching signal transmitted from the light pen, in which the peripheral lighting is turned on for the finger detection mode, and the peripheral lighting is turned off for the pen detection mode as illustrated in FIGS. 22 to 23.

If the optical touch sensor transits from the finger detection mode to the pen detection mode after detecting the existence of the light pen, the time required for the transition becomes long. Specifically, the optical touch sensor detects the existence of the light pen at one time point and then the optical touch sensor processes a first image capturing under a condition that the peripheral lighting is turned off at another time point, and then calculates coordinates of a pointing end of the light pen as illustrated in FIG. 24.

Therefore, when a user starts to write information using the light pen, a hand-written line is displayed on the display at a time point later than the time point that the optical touch sensor detects the existence of the light pen, and thereby the user cannot feel instantaneous writing-response, which can be obtained for pencils and ink pens. Further, due to the response-delay to the writing operation of the light pen, a starting end of a line that a user wants to draw cannot be displayed, which is known as “lack of line,” with which the user cannot feel the effective writing-response, which means that information input by an input device cannot be output smoothly.

Further, the optical touch sensor can detect the existence of the light pen by using another method, in which the light pen emits light when the light pen contacts the detection face, and the light pen does not emit light when the light pen does not contact the detection face. The optical touch sensor detects that the light pen contacts the detection face when the light is detected.

However, the above described methods cannot correctly detect a position of the light pen due to the effect of the peripheral lighting.

### SUMMARY

In one aspect of the present invention, a contact detection system is devised. The contact detection system includes a display to display an image, an object detection unit disposed at periphery of the display to detect a contact of an object on the display, a device detector to detect a first light emitted from an end of an input device to detect a contact of the input device on the display, and an information processing apparatus connectable to the display, the object detection unit, and the device detector via a network. The object detection unit includes a light source to emit a second light to an object. The device detector includes an image capturing device to capture an image using the first light emitted from the input device or using the second light emitted from the light source. The information processing apparatus includes an image acquisition unit to acquire an image captured by the image capturing device, and a control unit to control the light source to turn off the second light when a luminance-increased area caused by the first light exists in the image captured by using the first light and the second light and acquired by the image acquisition unit, and then the control unit to control the device detector to be ready to detect a contact of the input device to the display.

In another aspect of the present invention, a method of processing information for a system including a display to display an image, an object detection unit disposed at periphery of the display to detect a contact of an object on the display, a device detector to detect first light emitted from an end of an input device to detect a contact of the input device on the display, and an information processing apparatus connectable to the display, the object detection unit, and the device detector via a network is devised. The method includes the steps of emitting second light to an object from a light source included in the object detection unit, capturing an image using the first light emitted from the input device or the second light emitted from the light source, storing the image captured by the image capturing device in a memory, controlling the light source to turn off the second light when a luminance-increased area caused by the first light exists in the image captured by using the first light and the second light, and controlling the device detector to be ready to detect a contact of the input device to the display.

In another aspect of the present invention, an information processing apparatus connectable to a display to display an image, an object detection unit disposed at periphery of the display to detect a contact of an object on the display, the object detection unit including a light source, and a device detector to detect first light emitted from an end of an input device to detect a contact of the input device on the display, the device detector including an image capturing device, in which the information processing apparatus, the display, the object detection unit, and the device detector connectable one to another via a network is devised. The information processing apparatus includes an image acquisition unit to acquire an image captured by the image capturing device by using the first light emitted from the input device or an image captured by the image capturing device by using second light emitted from the light source, and a control unit to control the light source to turn off the second light when a luminance-increased area caused by the first light exists in the captured image and acquired by the image acquisition unit, and then to control the device detector to be ready to detect a contact of the input device to the display.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 schematically illustrates operation modes of a contact detection system of a first example embodiment;

FIG. 2 schematically illustrates transitions between the operation modes of FIG. 1;

FIG. 3 schematically illustrates operations of the contact detection system of the first example embodiment;

FIG. 4 illustrates a schematic configuration of the contact detection system of the first example embodiment;

FIG. 5 illustrates a schematic configuration of a light pen of the first example embodiment;

FIG. 6 illustrates a schematic hardware configuration of an information processing apparatus of the first example embodiment;

FIG. 7 illustrates a schematic block diagram of the contact detection system of the first example embodiment;

FIGS. 8A, 8B, and 8C illustrate examples of images captured in the first example embodiment;

FIG. 9 is a flow chart showing the steps of a finger detection mode in the first example embodiment;

FIGS. 10 A and 10B illustrate examples of images captured in the first example embodiment;

FIG. 11 is a flowchart showing the steps of processing in a hovering detection mode in the first example embodiment;

FIG. 12 is a flowchart showing the steps of processing in a hovering detection mode in the first example embodiment;

FIG. 13 is a flowchart showing the steps of processing in a pen detection mode in the first example embodiment;

FIG. 14 is a flowchart showing the steps of processing in a pen detection mode in the first example embodiment;

FIG. 15 is a timing chart showing a transition from the finger detection mode to the hovering detection mode in the first example embodiment;

FIG. 16 is a timing chart showing a transition from the hovering detection mode to the pen detection mode in the first example embodiment;

FIG. 17 illustrates a schematic configuration of a contact detection system of a second example embodiment;

FIG. 18 is a flowchart showing the steps of processing of the contact detection system of the second example embodiment;

FIG. 19 illustrates a schematic configuration of a contact detection system of a variant example of the second example embodiment;

FIG. 20 is a flowchart showing the steps of processing of the contact detection system of the variant example;

FIG. 21 is a timing chart showing a transition from a finger detection mode to a pen detection mode in conventional contact detection systems;

FIG. 22 schematically illustrates operation modes of conventional contact detection systems;

FIG. 23 schematically illustrates transitions between operation modes in conventional contact detection systems;

FIG. 24 schematically illustrates operations of conventional contact detection systems.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

A description is given of a contact detection system according to one or more example embodiments with reference to drawings.

### First Example Embodiment

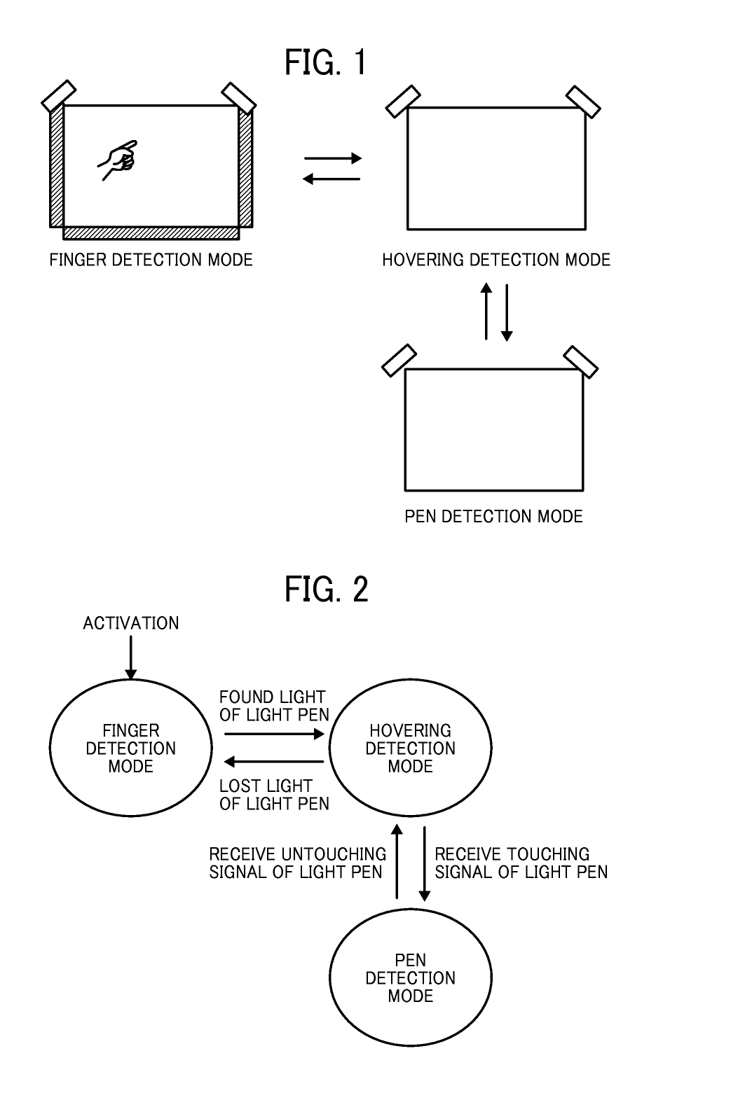

A description is given of operations of a contact detection system according to a first example embodiment with reference to FIGS. 1 to 3. An optical touch sensor of the first example embodiment employs two operation modes such as a finger detection mode and a pen detection mode, and further employs a hovering detection mode, which is a transitional mode or intermediately mode that can be switched or shifted to the finger detection mode and the pen detection mode as illustrated in FIG. 1. Therefore, the optical touch sensor according to the first example embodiment employs three operation modes as illustrated in FIGS. 1 and 2.

In the first example embodiment, as illustrated in FIG. 2, a transition from the finger detection mode to the hovering detection mode is triggered when light of a light-emittable pointing device (hereinafter, the light-emittable pointing device is referred to the “light pen” for the simplicity of expression) is found in an image obtained by using a lighting unit and detected and acquired by the optical touch sensor. Further, in the first example embodiment, a transition from the hovering detection mode to the pen detection mode is triggered when a touching signal transmitted from the light pen is received as illustrated in FIG. 2. In the first example embodiment, the lighting unit emits light (light-ON) during the finger detection mode, and the lighting unit turn off the light (light-OFF) during the hovering detection mode and the pen detection mode.

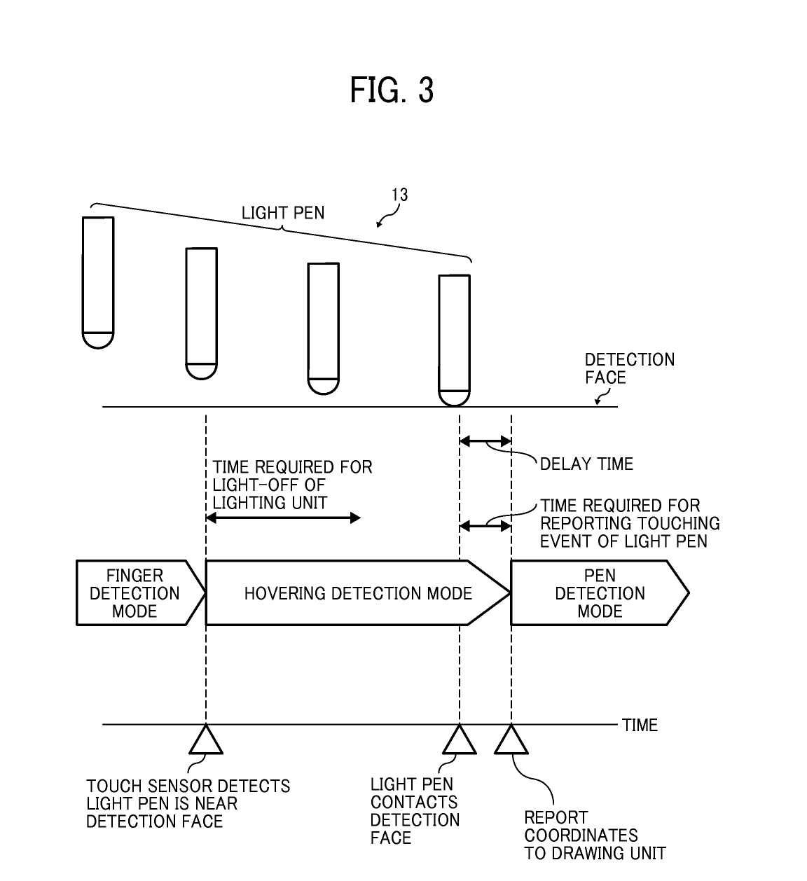

For example, when the light pen comes near a detection face during the finger detection mode, the light emitted from the lighting unit is turned off, and the operation mode transits or shifts to the hovering detection mode, and the contact detection system becomes ready to detect a touching of the light pen. When the light pen touches the detection face during the hovering detection mode, coordinates of a pointing end of the light pen can be calculated without performing the light-OFF operation of the lighting unit, in which the delay time caused by the light-OFF operation of the lighting unit is not included in the total delay time as illustrated in FIG. 3.

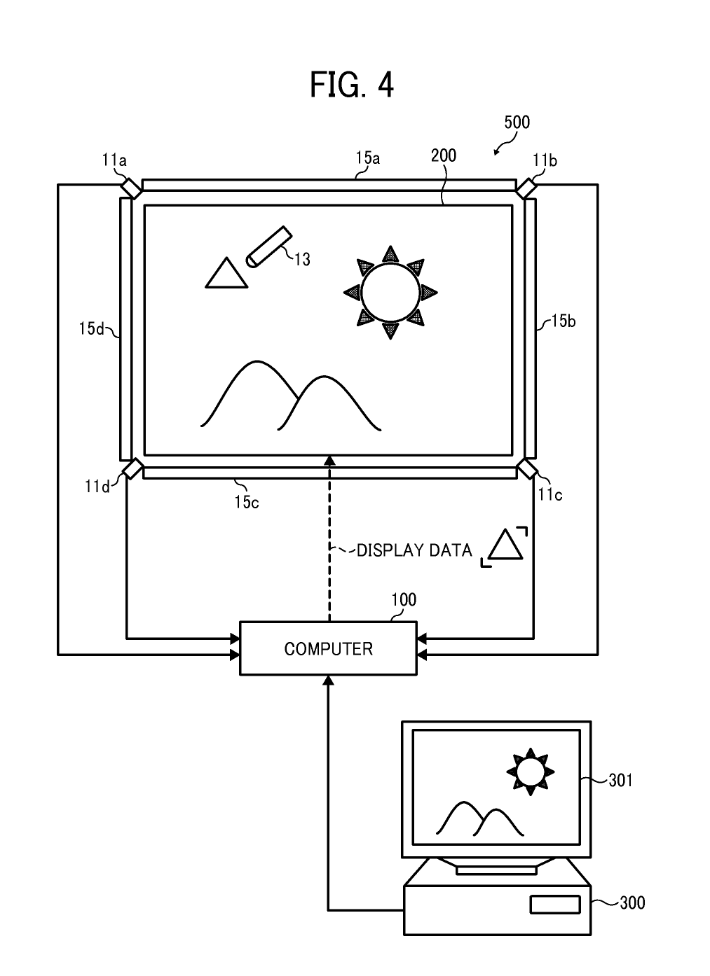

A description is given of a schematic configuration of a contact detection system 500 according to the first example embodiment with reference to FIG. 4. The contact detection system 500 includes, for example, a display 200, four detectors 11a to 11d, four lighting units 15a to 15d, a computer 100, and a personal computer (PC) 300. In this description, one or more detectors 11 may be referred to the detector 11, and one or more lighting units 15 may be referred to the lighting unit 15 for the simplicity of expressions. The lighting unit 15 can be disposed at peripherals of the display 200 as illustrated in FIG. 4.

Each of the four lighting units 15a to 15d can be disposed at peripherals of the display 200 as a detachable unit. Further, the computer 100 is connectable to the PC 300. The computer 100 preferably has a capability or function to display images such as still images and movie images, received from the PC 300, on the display 200.

The computer 100 can be installed with one or more applications used for the contact detection system 500. For example, one application can be used to detect a position of the light pen 13 used as an input device by a user based on a signal from the detector 11. The application analyzes operations based on the position of the light pen 13, and controls the computer 100. Further, other application can be used to display a menu image used for instructing operations on the display 200.

For example, when a user touches a menu image for drawing a line, and then places the light pen 13 on a surface of the display 200 to draw a line, the computer 100 can analyze a position touched by the light pen 13 real time, and then generates time series coordinates of the light pen 13, in which the computer 100 generates a line by connecting the time series coordinates of the light pen 13, and displays the line on the display 200.

In an example of FIG. 4, when a user moves the light pen 13 on the display 200 to write a triangular figure, the computer 100 stores time series coordinates of the light pen 13 as a triangular image expressed by one stroke, and then the computer 100 can synthesize the triangular image with an image output from the PC 300 and displays a synthesis image on the display 200.

In this configuration, the display 200 does not have a touch panel function or capability, but a user can perform various operations by touching the display 200 with the light pen 13 employed for the contact detection system 500. Further, to be described later, the user can input positions using a hand or finger instead of using the light pen 13.

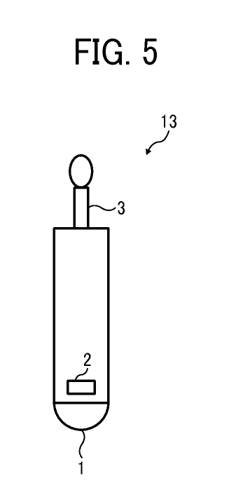

A description is given of a schematic configuration of the light pen 13 of the first example embodiment with reference to FIG. 5. When a user touches a menu image used for drawing a line, and draws a line on the display 200 by using the light pen 13 having a light emission unit at a pointing end of the light pen 13, the computer 100 analyzes positions touched by the light pen 13 real time based on the light emitted from the light emission unit of the light pen 13, and generates time series coordinates of the light pen 13. The computer 100 connects the time series coordinates of the light pen 13 to generate and display one or more lines on the display 200.

As illustrated in FIG. 5, the light pen 13 includes, for example, a light emission unit 1, a contact detection unit 2, and a wireless reporting unit 3. The light emission unit 1 including a light emission element can emit, for example, infrared light. The contact detection unit 2 can detect physical touching and untouching of the light emission unit 1 on a detection face of the display 200. The wireless reporting unit 3 can report touching and untouching information detected by the contact detection unit 2 to the computer 100 by using wireless signals. The light pen 13 can store attribution information such as identification (ID) data unique to each one of light pens in a memory. The wireless reporting unit 3 can be configured to transmit a touch signal or untouching signal with the ID data of the light pen 13.

With this configuration, the computer 100 can identify the light pen 13 uniquely that transmits a touching or untouching signal. In the above configuration, the light emission unit 1 can be configured to emit light always but not limited hereto. For example, the light emission unit 1 can be provided with a sensor such as an accelerometer for estimating a use condition by a user. Based on an output signal of the sensor such as the accelerometer, it can determine whether the light pen 13 is used, and the light emission unit 1 can be configured to put the light off when it is determined that the light pen 13 is not used.

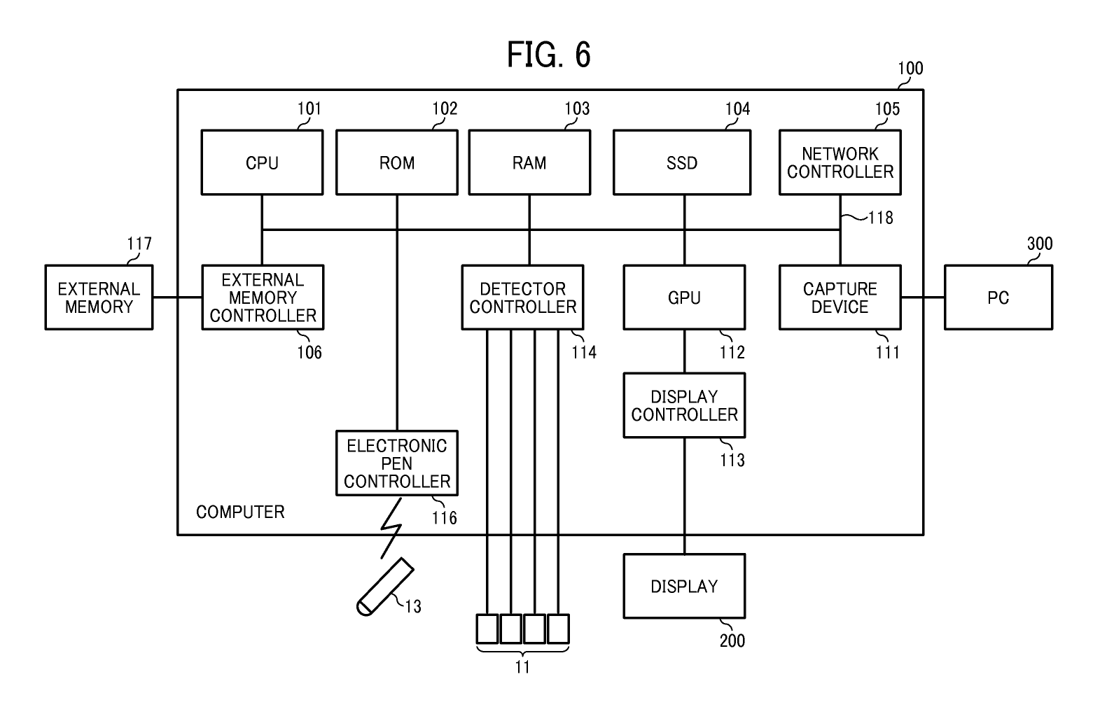

A description is given of a hardware configuration of the computer 100 useable as an information processing apparatus for the contact detection system 500 according to the first example embodiment with reference to FIG. 6. The computer 100 includes, for example, a central processing unit (CPU) 101, a read only memory (ROM) 102, a random access memory (RAM) 103, and a solid state drive (SSD) 104 electrically connectable one to another via a bus line 118 such as address bus and data bus.

The computer 100 can further include a network controller 105, an external memory controller 106, a detector controller 114, a graphics processor unit (GPU) 112, and a capture device 111. The computer 100 can further include a display controller 113, and an electronic pen controller 116.

The CPU 101 executes applications to control the entire of the contact detection system 500. The ROM 102 stores an initial program loader (IPLI), and stores programs executable by the CPU 101 when the computer 100 is activated. The RAM 103 can be used as a working area when the CPU 101 executes the applications. The SSD 104 is a non-volatile memory that stores application 119 and various data used for the contact detection system 500.

The network controller 105 controls communication with a server via a network based on communication protocols. Further, the network can be the Internet, a local area network (LAN), or a wide area network (WAN) configured by connecting a plurality of LANs.

The external memory controller 106 can write data to an external memory 117 and read out data from the external memory 117. The external memory 117 is a detachable external memory such as a universal serial bus (USB) memory, a secure digital (SD) card (registered trademark) or the like. The capture device 111 captures images displayed on a display 301 of the PC 300. The GPU 112 is a drawing processor or circuit that computes a value of each pixel of the display 200. The display controller 113 outputs image data generated by the GPU 112 to the display 200.

The detector controller 114 is connected to the four detectors 11a to 11d. The detector controller 114 performs coordinates detection by employing the triangulation method that uses an infrared light blocking method and pen light emission method. The detail of the detector controller 114 will be described later.

Further, in the first example embodiment, the computer 100 is not required to communicate with the light pen 13. However, the computer 100 can include the electronic pen controller 116 that can communicate with the light pen 13. In this case, the electronic pen controller 116 can receive a press signal from the light pen 13 via a communication with the reporting unit 3 of the light pen 13. With this configuration, the computer 100 can detect whether the pointing end (light emission unit 1) of the light pen 13 is pressed on the display 200.

Further, applications used for the contact detection system 500 can be distributed by storing the applications in the external memory 117, or can be downloaded from a server via the network controller 105. Further, the applications can be downloaded as compressed data or executable format data.

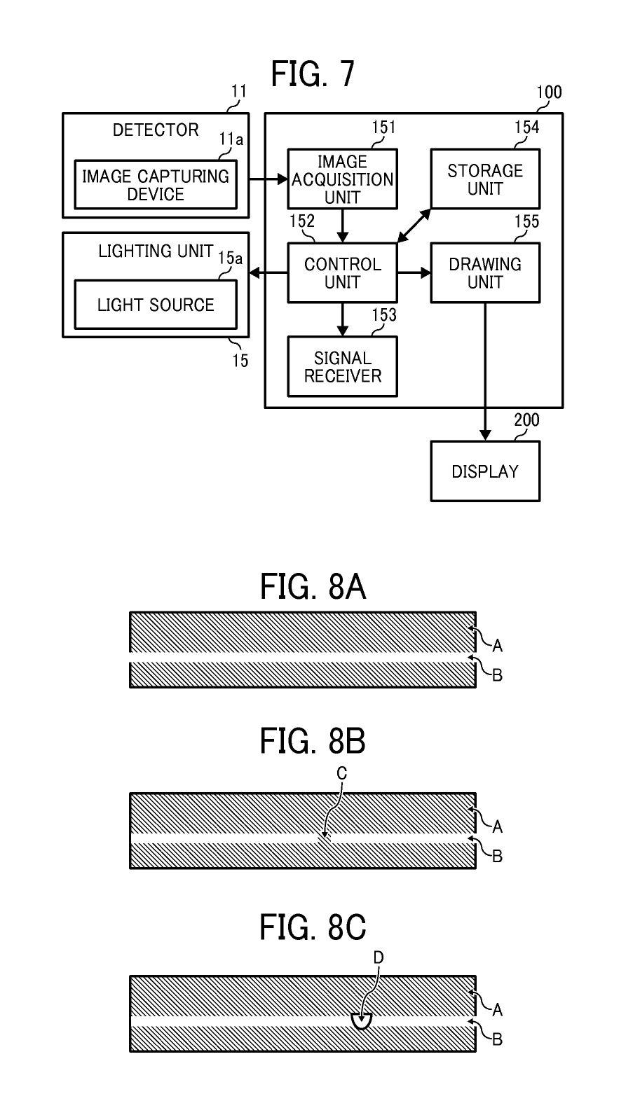

A description is given of functional configuration of the contact detection system 500 of the first example embodiment with reference to FIG. 7. The functional configuration of the contact detection system 500 can be configured with the detector 11, the lighting unit 15, and functional blocks of the computer 100. The computer 100 includes, for example, an image acquisition unit 151, a control unit 152, a signal receiver 153, a storage unit 154, and a drawing unit 155.

The detector 11 is used as a device detector that can detect a contact of the light pen 13 on the display 200 by detecting light (first light) emitted from a pointing end (light emission unit 1) of the light pen 13. The detector 11 includes an image capturing device 11a such as an image sensor that captures an image by using light (first light) emitted from the light pen 13, and infrared light (second light) emitted from a light source 15a of the lighting unit 15 to capture an image near a surface of the display 200.

One or more of the lighting units 15 disposed at peripheral of the display 200 can be used as an object detection unit that detects a contact of an object on the display 200. Further, in the first example embodiment, as illustrated in FIG. 4, the four lighting units 15a to 15d are disposed, but the number of lighting units 15 is not limited four. The image acquisition unit 151 is used as an image acquisition unit that acquires images captured by the image capturing device 15a.

An image captured by using the light (first light) emitted from the light pen 13 and an image captured by using the light (second light) emitted from the lighting unit 15 can be acquired by the image acquisition unit 151. When a luminance-increased area exists in the captured image due to the light (first light) emitted from the light pen 13, the control unit 152 controls the light source 15a (FIG. 7) to turn off the light (second light) of the light source 15a, and further, the control unit 152 controls the detector 11 to be ready to detect a contact of the light pen 13 on the display 200. The control unit 152 controls the lighting unit 15 to control switching of ON and OFF of the light source 15a (FIG. 7). Specifically, the control unit 152 performs a switching control of the three operation modes illustrated in FIG. 2. The switching control will be described later.

The drawing unit 155 is used as a drawing unit (drawing application) to draw an image such as a hand writing line on the display 200. When an image captured by using the light (second light) of the light source 15a includes a portion blocked by an object, the image acquisition unit 151 acquires an image having an area that decreases luminance (hereinafter, luminance-decreased area). When the luminance-decreased area (i.e., area blocked by object) is detected by using the lighting unit 15, the control unit 152 calculates coordinates of a position of the object that contacts the display 200, and controls the drawing unit 155 to start the drawing from the calculated coordinates.

Specifically, when a user uses the light pen 13 or a pointing tool that does not emit light such as a hand or finger to input hand writing lines to the display 200, the control unit 152 reports coordinates of the light pen 13 or the pointing tool to the drawing unit 155 while distinguishing the light pen 13 and the pointing tool.

The storage unit 154 is a storage medium such as a memory that stores coordinates data corresponding to the coordinate position of the light pen 13 on the display 200. For example, the storage unit 154 can be implemented by the ROM 102 shown in FIG. 6.

When an image is captured by using the light (first light) emitted from the light pen 13 and the light (second light) emitted from the lighting unit 15 and then acquired by the image acquisition unit 151, a luminance-increased area caused by the light (first light) emitted from the light pen 13 can be detected in the captured image. In this case, the control unit 152 calculates coordinates of a position of the light pen 13, detected by the detector 11 that the light pen 13 contacts the display 200, and controls the storage unit 154 to store coordinates data corresponding to the calculated coordinate position of the light pen 13.

The signal receiver 153 is used as a signal receiver that receives a touching signal or untouching signal transmittable from the light pen 13. Upon receiving the touching signal by the signal receiver 153, the control unit 152 controls the drawing unit 155 to start the drawing from the coordinate position of the light pen 13 identified by the coordinates data stored in the storage unit 154. By contrast, upon receiving the untouching signal by the signal receiver 153, the control unit 152 controls the lighting unit 15 to be ready to detect a contact of an object on the display 200.

FIG. 8A is an example of an image captured by the detector 11, in which a white area B is an image captured by using the light (second light) emitted from the lighting unit 15, and a slashed area A corresponds to, for example, a background image.

FIG. 8B is an example of an image captured by the detector 11 during the finger detection mode. This image can be captured when a user operates the display 200 using a finger, in which a portion C that interrupts the white area B corresponds to a portion where the light (second light) emitted from the lighting unit 15 is blocked by the finger.

FIG. 8C is another example of an image captured by the detector 11 during the finger detection mode. This image can be captured when a user places the light emission unit 1 of the light pen 13 at a close range of the surface of the display 200, in which an image D corresponding to the light (first light) emitted from the light pen 13 is superimposed on an image captured by using the light (second light) emitted from the lighting unit 15.

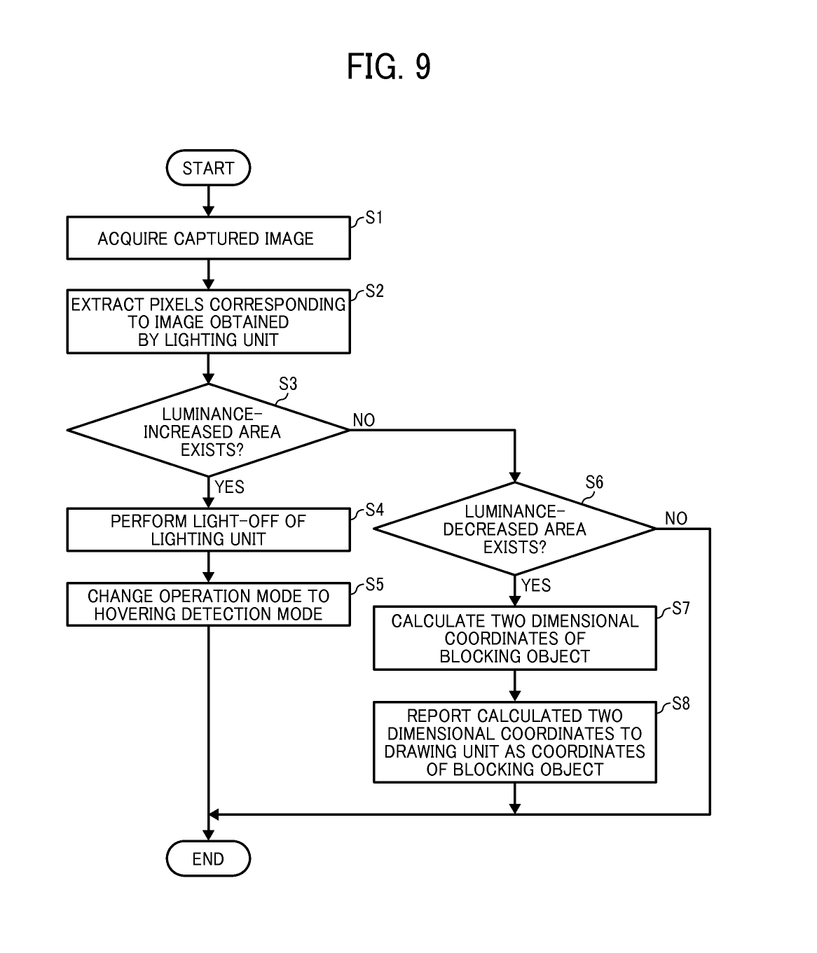

A description is given of processing during the finger detection mode of the first example embodiment with reference to FIG. 9, in which a timer to be activated with a given time cycle (i.e., timer event) is disposed, and the processing is started (START) when the timer event occurs.

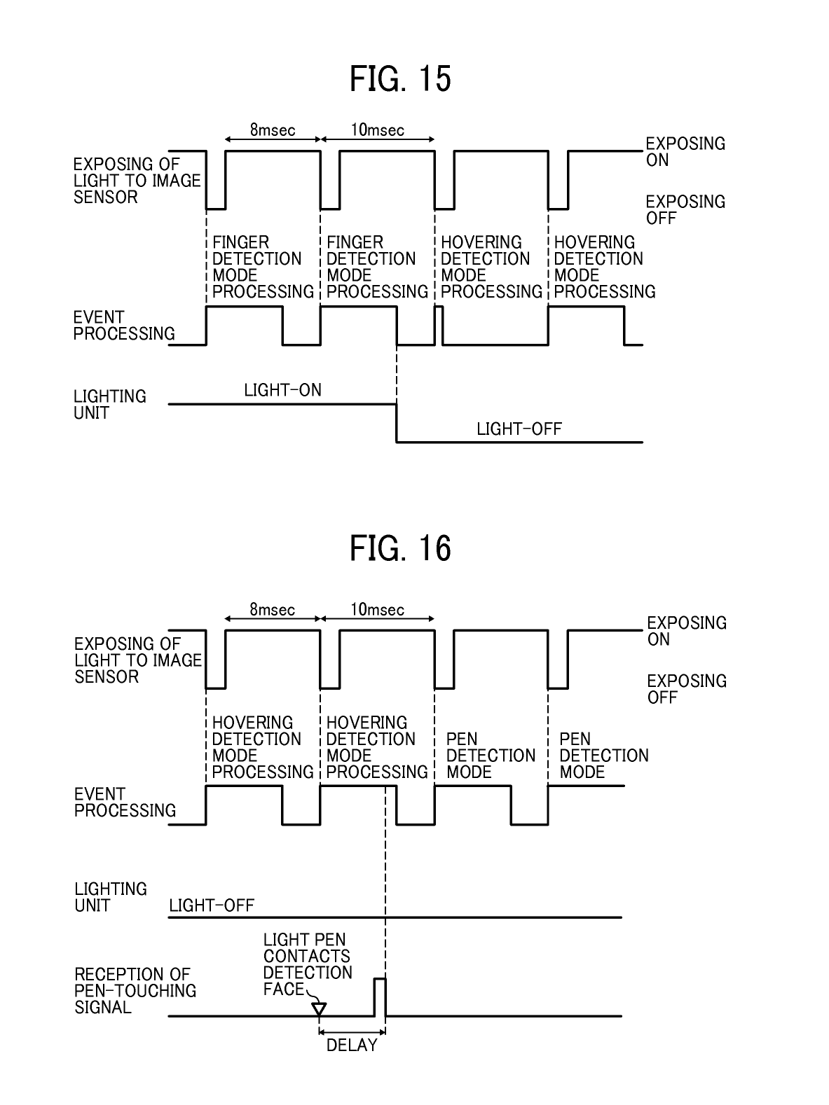

The detector 11 includes the image capturing device 11a such as an image sensor exposed to light for a given time period with a given time cycle. As to the first example embodiment, the timer event is preferably activated right after completing the exposure of the image sensor of the detector 11. As illustrated in FIG. 15, one cycle of the timer event is set, for example, 10 msec, and an exposure time is set, for example, 8 msec, but not limited these.

After acquiring a captured image by using the image acquisition unit 151 (step S1), the control unit 152 extracts pixels, corresponding to an image area obtainable by using the light (second light) emitted from the lighting unit 15, from the captured image (step S2). An image of the white area B (FIG. 8A) is captured by using the light (second light) emitted from the lighting unit 15 when no blocking objects exist. The image of white area B can be stored in the storage unit 154 in advance. Further, the image of the white area B can be captured by capturing images with a given time cycle during the finger detection mode and detecting an image when no blocking objects exist.

The control unit 152 compares the extracted pixels and pixels corresponding to the image of the white area B stored in the storage unit 154 to determine whether an area having increased luminance (hereinafter, luminance-increased area) caused by the light (first light) emitted from the light emission unit 1 of the light pen 13 exists (step S3).

When the control unit 152 determines that the luminance-increased area exists (step S3: YES), the control unit 152 determines that the light pen 13 exists, and the control unit 152 turns off the light (second light) of the lighting unit 15 (step S4), and changes the operation mode from the finger detection mode to the hovering detection mode (step S5).

In the above configuration, the existence of the light pen 13 is determined based on the image captured by one detector 11, but the existence of the light pen 13 can be determined using other configuration. For example, the existence of the light pen 13 can be determined based on images captured by two detectors 11. Specifically, when two or more detectors 11 among all of the detectors 11 disposed for the optical touch sensor detect the light pen 13, the operation mode can be transited.

By contrast, when the control unit 152 determines that the luminance-increased area does not exist (step S3: NO), the control unit 152 determines whether an area having decreased luminance (hereinafter, luminance-decreased area) caused by a blocking object exists (step S6). If the control unit 152 determines that the luminance-decreased area exists (step S6: YES), the control unit 152 determines that the blocking object such as a finger exists, and calculates two dimensional coordinates indicating a position where the finger exists on the display 200 (step S7).

Then, the control unit 152 reports the calculated coordinates to the drawing unit 155 as the position of the finger on the display 200 (step S8). The calculation process of coordinates can be conducted by employing, for example, the triangulation method for the optical touch sensor.

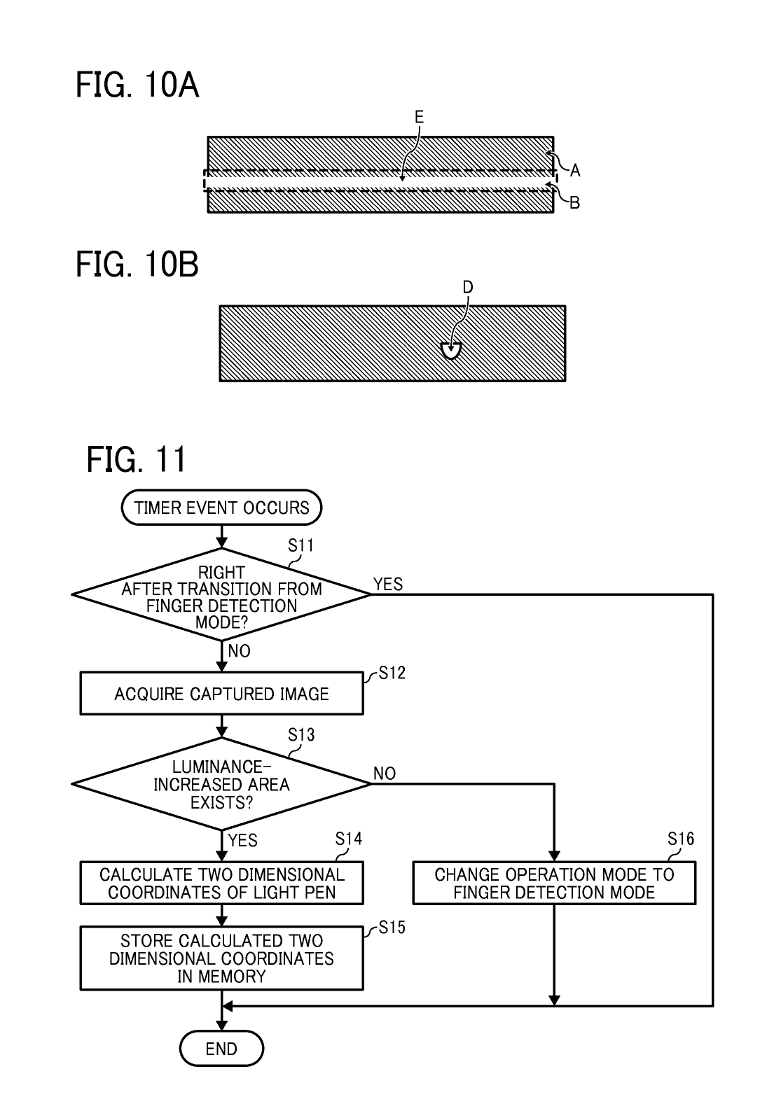

In the above described processing, an area irradiated by the light (second light) of the lighting unit 15 is extracted from the image captured by the detector 11, and compared to detect the existence of the light pen 13. Instead of the white area B of FIG. 8A, a rectangular area E indicated by a dashed line in FIG. 10A can be used. The rectangular area E including an area irradiated by the light (second light) emitted from the lighting unit 15 can be set larger than the white area B of FIG. 8A. Further, the entire captured image can be used instead of a partial captured image such as the white area B of FIG. 8A. By setting different areas, when a user places the light pen 13 closer to the display 200, a switching timing from the finger detection mode to the hovering detection mode can be changed.

FIG. 10B is an example of image captured by the detector 11 during the hovering detection mode. This image can be captured when a user places the light pen 13 closer to the surface of the display 200. An area irradiated by the light (first light) emitted from the light emission unit 1 of the light pen 13 can be captured as the image D as shown in FIG. 10B.

A description is given of a processing during the hovering detection mode of the first example embodiment with reference to FIG. 11, in which similar to the finger detection mode shown in FIG. 9, the processing of FIG. 11 is activated (START) when the timer event occurs at a given time cycle. In this processing of FIG. 11, right after the transition to the hovering detection mode from the finger detection mode such as at just right after the transition (step S11: YES), the control unit 152 does not conduct any processes but ends the sequence (END), wherein the reason will be described later.

If it is not right after the transition from the finger detection mode (step S11: NO), an image captured by the detector 11 is acquired (step S12), and then the control unit 152 determines whether a luminance-increased area exists in the captured image (step S13). If the control unit 152 determines that the luminance-increased area exists (step S13: YES), the control unit 152 determines that the light pen 13 exists, and calculates two dimensional coordinates indicating a position where the light pen 13 exists on the display 200 (step S14).

Then, the control unit 152 stores the calculated coordinates in the storage unit 154 (step S15). As to the first example embodiment, a data structure in the storage unit 154 is preferably a ring buffer or circular buffer but not limited hereto.

By contrast, if the control unit 152 determines that the luminance-increased area does not exist (step S13, NO), the control unit 152 changes the operation mode from the hovering detection mode to the finger detection mode (step S16), and ends the sequence.

After acquiring the captured image, the control unit 152 determines whether the luminance-increased area exists in the image captured by the detector 11 at step S13 by using the entire image, but not limited hereto. For example, a partial image including an area irradiated by the light (second light) emitted from the lighting unit 15 such as the rectangular area E shown in FIG. 10A can be used instead of the entire captured image.

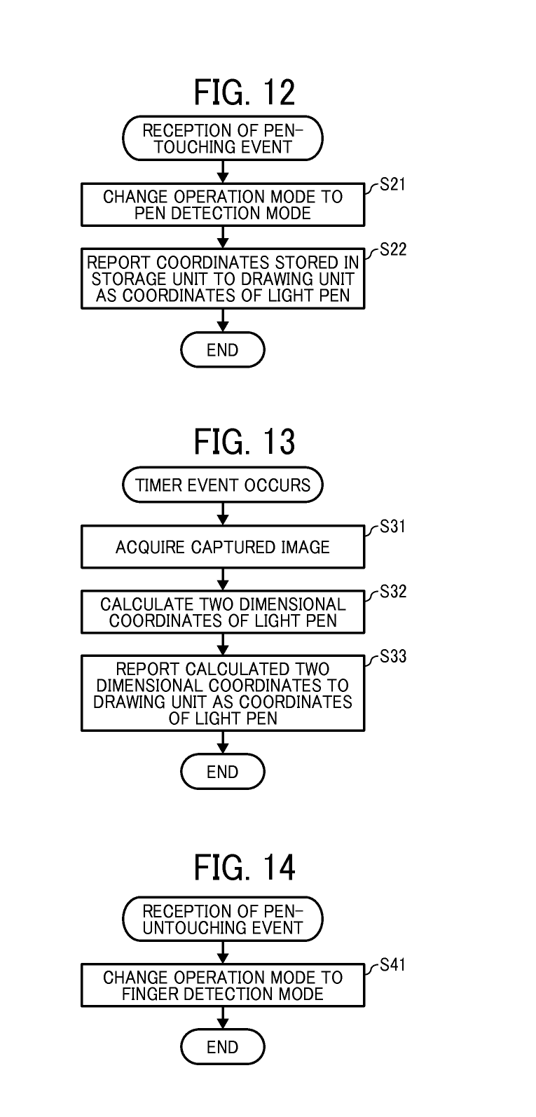

A description is given of processing after receiving a pen-touching event during the hovering detection mode with reference to FIG. 12. When the signal receiver 153 receives a touching signal transmitted from the light pen 13, the control unit 152 starts a pen-touching event reception process, and changes the operation mode from the hovering detection to the pen detection mode (step S21). Then, the control unit 152 reports the latest value stored in the storage unit 154 to the drawing unit 155 as coordinates of a position of the light pen 13 (step S22).

In this configuration, the control unit 152 can report the one latest value to the drawing unit 155 stored in the storage unit 154 but not limited hereto. For example, the control unit 152 can report a plurality of coordinate values stored in the storage unit 154 to the drawing unit 155 from the oldest value. Further, since the drawing unit 155 starts the drawing after receiving the coordinates from the control unit 152, it is preferable to start the drawing on the display 200 right after receiving a touching signal transmitted from the light pen 13.

A description is given of processing during the pen detection mode of the first example embodiment with reference to FIG. 13, in which similar to the finger detection mode shown in FIG. 9, the processing of FIG. 13 is activated (START) when the timer event occurs at a given time cycle.

After the image acquisition unit 151 acquires an image captured by the detector 11 (step S31), the control unit 152 detects an area corresponding to the light (first light) emitted from the light pen 13 in the captured image, and calculates coordinates indicating a position where the light pen 13 exists on the display 200 (step S32). Then, the control unit 152 reports the calculated coordinates to the drawing unit 155 as the coordinates of the light pen 13 on the display 200 (step S33).

A description is given of processing after receiving a pen-untouching event during the pen detection mode with reference to FIG. 14. When the signal receiver 153 receives a untouching signal transmitted from the light pen 13, the control unit 152 starts the pen-untouching event reception process, and changes the operation mode from the pen detection mode to the finger detection mode (step S41).

A description is given of a transition timing from the finger detection mode to the hovering detection mode of the first example embodiment with reference to FIG. 15. As to the first example embodiment, the image capturing device 11a such as the image sensor of the detector 11 is exposed to light for a given time period in one exposure period while the exposure period occurs with a given time cycle as illustrated in FIG. 15. For example, the image sensor of the detector 11 is exposed to light for 8 msec in each 10 msec as illustrated in FIG. 15, and the computer 100 starts an event processing when each time the exposure ends. The event processing is different for each of the operation modes. FIG. 15 shows an example case before and after the transition to the hovering detection mode, in which the light pen 13 is detected during the event processing of the finger detection mode, with which the lighting unit 15 is turned off, and the operation mode transits from the finger detection mode to the hovering detection mode.

Further, as illustrated in FIG. 15, when the time required for processing the finger detection mode is longer than the exposure interval time (e.g., 2 msec), an image captured at the first event processing right after the transition to the hovering detection mode may include an image area irradiated by the lighting unit 15. When the image area irradiated by the lighting unit 15 is included in the captured image, the position of the light pen 13 cannot be detected correctly from the captured image. Therefore, the processing is not performed right after the transition from the finger detection mode to the hovering detection mode as described at step 11 shown in FIG. 11. For example, if the time required for processing the finger detection mode is further longer, a plurality of event processing right after the transition to the hovering detection mode is skipped in view of the above mentioned image area irradiated by the lighting unit 15.

A description is given of a transition timing from the hovering detection mode to the pen detection mode of the first example embodiment with reference to FIG. 16. Specifically, when the light pen 13 contacts the display 200 and then a given time elapses, the computer 100 receives a pen-touching signal during the hovering detection mode. Upon receiving the pen-touching signal, the computer 100 starts the pen-touching event reception process (FIG. 12), and then the coordinates stored in the storage unit 154 in advance is reported to the drawing unit 155 as the coordinates of the light pen 13.

The delay time can be defined as a time interval from a time point when the light pen 13 contacts the display 200 to a time point when the coordinate value is reported to the drawing unit 155 as shown in FIG. 16.

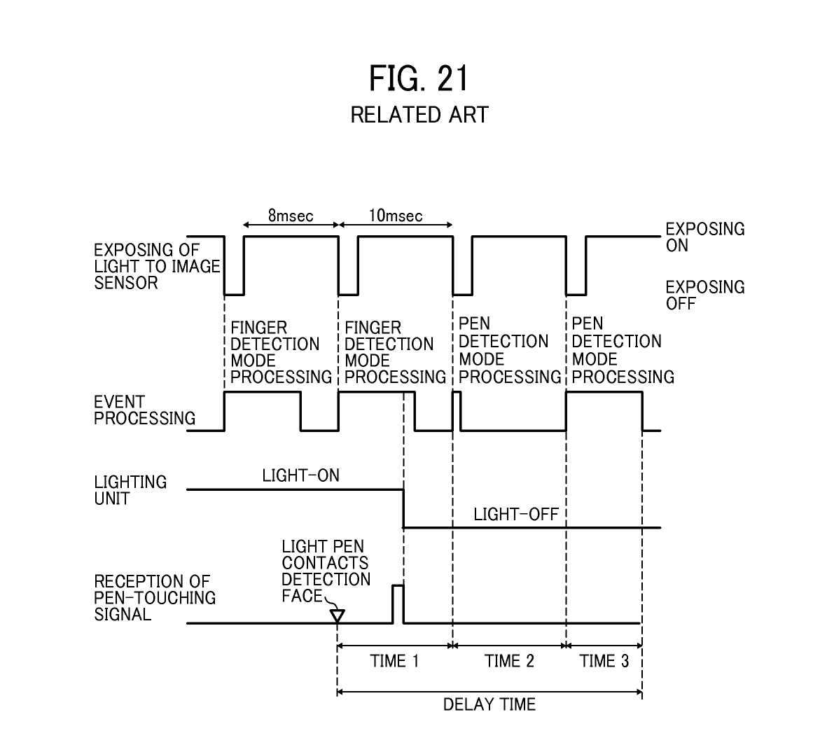

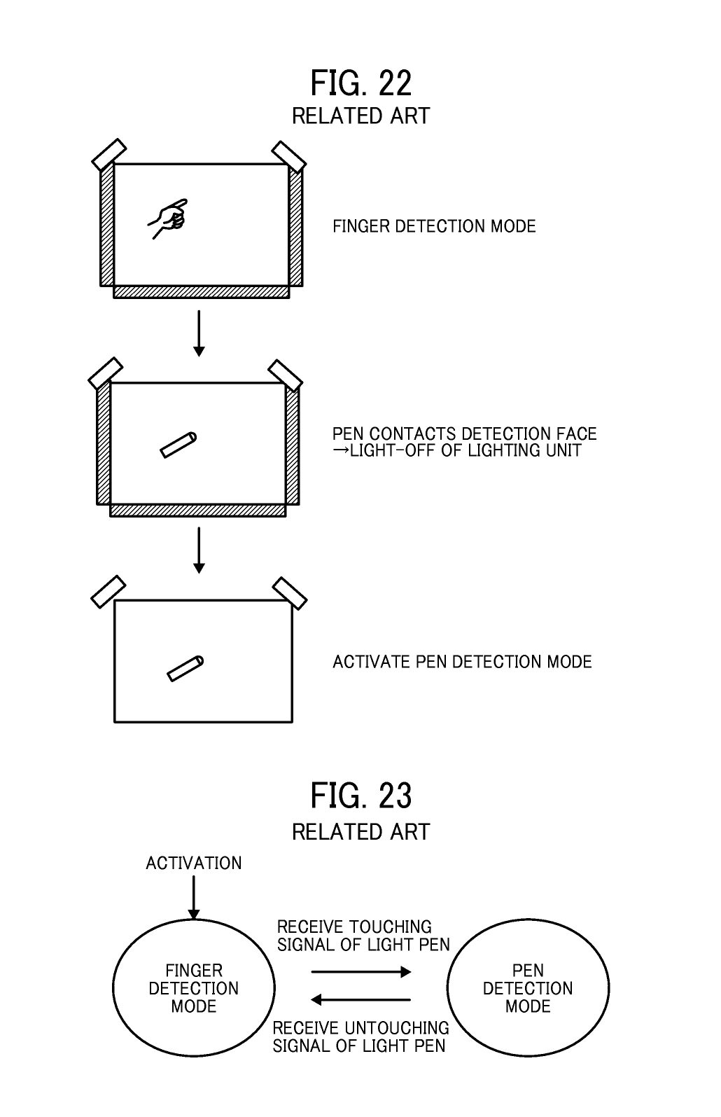

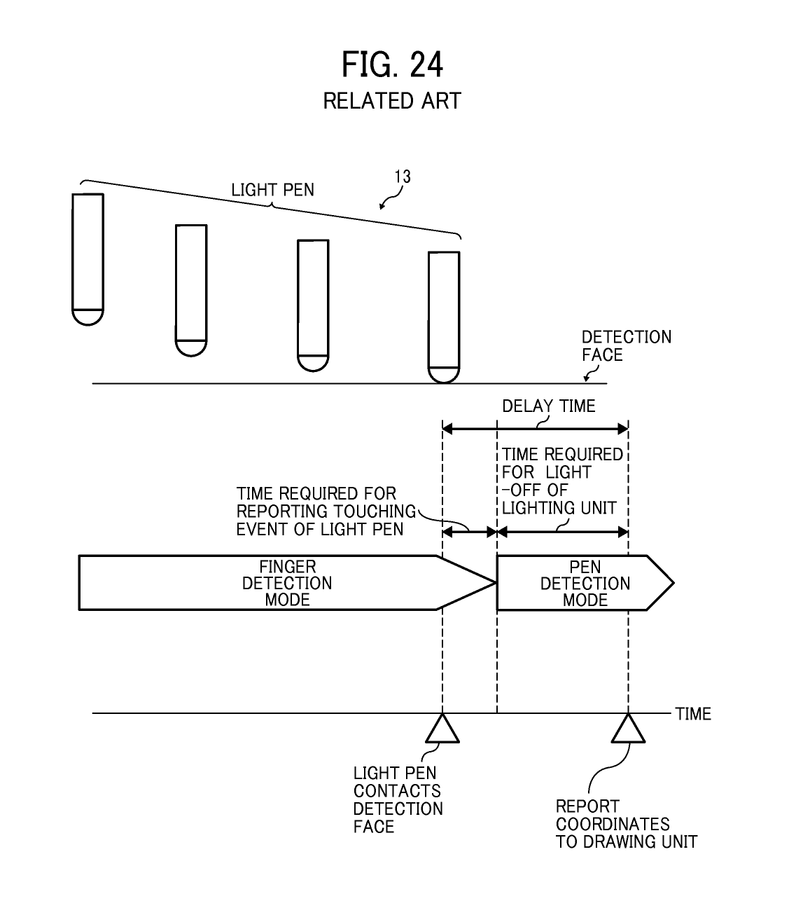

A description is given of a transition timing from the finger detection mode to the pen detection mode in conventional systems with reference to FIG. 21. A description is given of a delay time of an optical touch sensor in conventional systems, which is longer than the delay time of the optical touch sensor of the first example embodiment. The optical touch sensor of conventional systems employs two operation modes such as the finger detection mode and the pen detection mode, in which a transition from the finger detection mode to the pen detection mode is triggered when a pen-touching signal is received.

As illustrated in FIG. 21, the delay time of the optical touch sensor in conventional systems is composed of Time “1,” Time “2,” and Time “3.” Specifically, Time “1” is from a pen touching to the start of event processing right after the reception of the pen-touching signal such as “0 to 8 msec,” Time “2” corresponds to time of skipping of the event processing right after the transition to the pen detection mode such as “10 msec,” and Time “3” corresponds to time required to calculate coordinates in the event processing of the pen detection mode. Therefore, the total delay time (Time “1”+Time “2”+Time “3”) becomes longer than the delay time of the optical touch sensor of the first example embodiment shown in FIG. 16.

### Second Example Embodiment

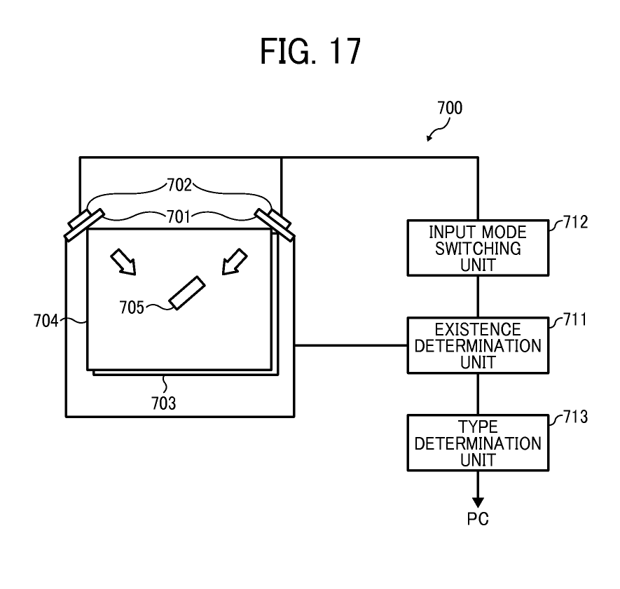

A description is given of a schematic configuration of a contact detection system 700 according to a second example embodiment with reference to FIG. 17. Different from the first example embodiment, the contact detection system 700 of the second example embodiment switches two operation modes such as the finger detection mode and the pen detection mode.

As illustrated in FIG. 17, the contact detection system 700 includes, for example, a detector 701, a lighting unit 702, a display 703, a retroreflector 704, an existence determination unit 711, an input mode switching unit 712, and a type determination unit 713. The existence determination unit 711, the input mode switching unit 712, and the type determination unit 713 can be divised by one or more processing circuits or circuitry. Further, a pointing tool 705 can be used on or over the display 703. The pointing tool 705 can be a finger, a light pen, or any objects detectable by the detector 701.

The detector 701 can detect an object such as a finger and a light pen. The detector 701 corresponds to the device detector such as the image capturing device 11a described in the first example embodiment. A detection result of the detector 701 is transferred to the existence determination unit 711.

The lighting unit 702 can emit light such as infrared light (second light) that can pass through the display 703 and reach the retroreflector 704. The lighting unit 702 includes, for example, a light receiver that receives light such as reflection light reflected from the retroreflector 704. When an object blocks the light (second light) emitted from the lighting unit 702, and the light receiver cannot detect the reflection light reflected from the retroreflector 704, it can be assumed that an object exists. An object detection result obtained by using the lighting unit 702 is transferred to the input mode switching unit 712. As such, the lighting unit 702 can be used as an object detection unit that detects an object when the light (second light) emitted from the lighting unit 702 is blocked.

The existence determination unit 711 determines whether the pointing tool 705 exists based on a detection result of the detector 701.

The input mode switching unit 712 switches the input mode based on a determination result of by the existence determination unit 711 that determines whether the pointing tool 705 exists. The input mode includes the finger detection mode and the pen detection mode.

When the existence determination unit 711 determines that the pointing tool 705 exists, the type determination unit 713 determines whether the pointing tool 705 is, for example, a finger or a light pen, and calculates feature of the pointing tool 705. Based on the feature calculated by the type determination unit 713, the PC performs information processing such as pen-inputting process using the light pen and finger-inputting process using a finger.

The feature of the pointing tool 705 includes, for example, coordinates, numbers, size, and detection time of the pointing tool 705. In FIG. 17, the light-blocking system is configured by disposing the lighting unit 702 near the detector 701 and the retroreflector 704 outside the display 703, but other configurations can be employed. For example, a peripheral lighting unit can be employed.

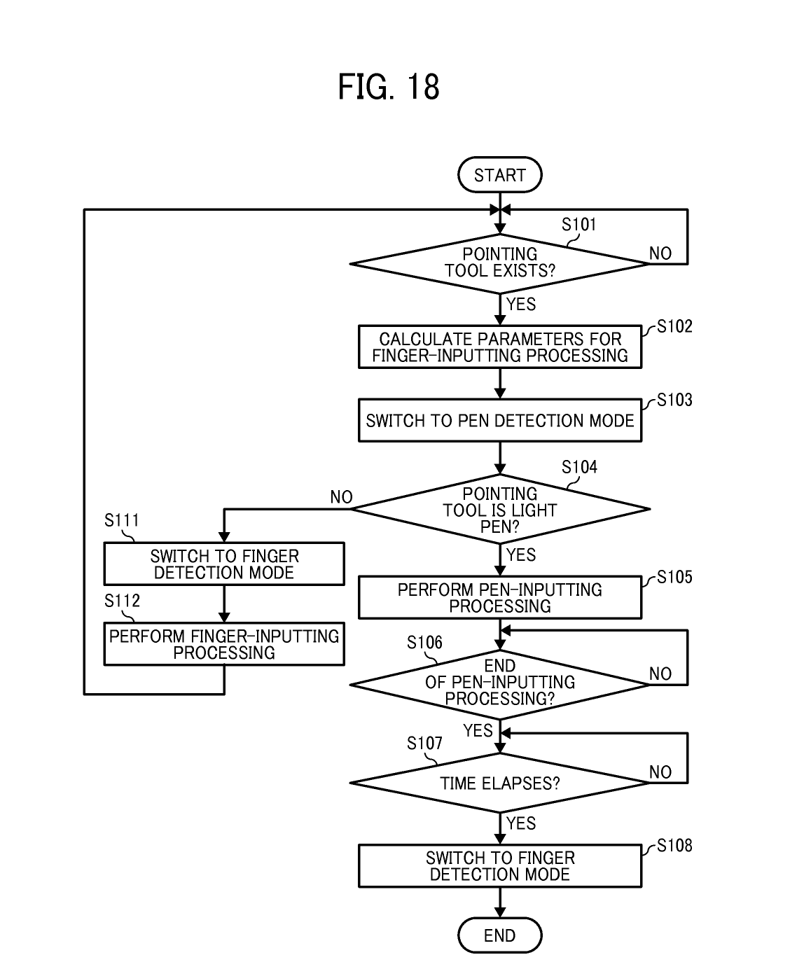

A description is given of processing of the second example embodiment with reference to FIG. 18. At first, the existence determination unit 711 determines whether the pointing tool 705 exists based on a detection result of the detector 701 (step S101).

When the existence determination unit 711 determines that the pointing tool 705 exists (step S101: YES), the personal computer (PC) calculates parameters for finger-inputting process based on an area blocked by the pointing tool 705 identified by the detection result of the detector 701 (step S102). The parameters for finger-inputting process include, for example, coordinates, numbers, size, and detection time. By contrast, when the existence determination unit 711 determines that the pointing tool 705 does not exist (step S101: NO), the existence determination process is continued.

When the existence determination unit 711 determines that the pointing tool 705 exists (step S101: YES), and the parameters for finger-inputting processing are calculated (step S102), the input mode switching unit 712 switches the operation mode from the finger detection mode (default mode) to the pen detection mode without consideration to the type of the pointing tool 705 (step S103). With this configuration, the pen-inputting processing after the mode switching can be performed without delay. Further, after switching to the pen detection mode, the lighting unit 702 turn off the light (second light).

The type determination unit 713 determines whether the pointing tool 705 is a finger or a light pen based on the detection result of the detector 701 (step S104).

When the type determination unit 713 determines that the pointing tool 705 is the light pen (step S104: YES), the feature of the light pen is calculated based on the detection result of the detector 701. The PC performs the pen-inputting process upon receiving the feature of the light pen.

After completing the pen-inputting process by the PC (step S106: YES), and when a timer detects that a given time elapses (step S107: YES), the input mode switching unit 712 switches the operation mode from the pen detection mode to the finger detection mode by turning on the light (second light) of the lighting unit 702 (step S108).

By contrast, when the type determination unit 713 determines that the pointing tool 705 is an object such as a finger, a palm, or a sleeve that is other than the light pen (step S104: NO), since an image caused by the light (first light) emitted from the light pen is not detected in the captured image as indicated by the detection result of the detector 701, the type determination unit 713 determines that the pointing tool 705 is an object other than the light pen. Upon receiving a detection result of the type determination unit 713, the input mode switching unit 712 switches the operation mode from the pen detection mode to the finger detection mode (step S111).

Then, upon receiving the detection result of the type determination unit 713, the PC performs the finger-inputting process using the parameters for finger-inputting process calculated by the existence determination unit 711 (step S112), and further, the input mode switching unit 712 controls the lighting unit 702 to turn on the light (second light) so that the pointing tool 705 can be detected.

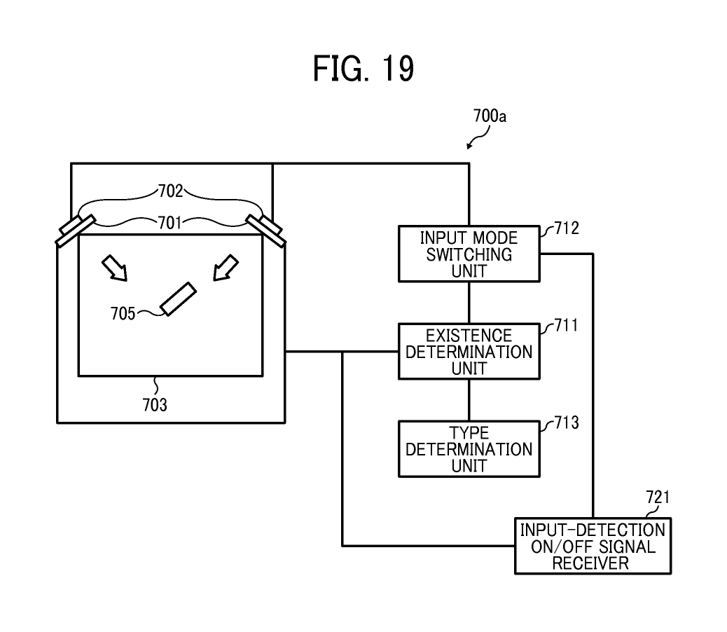

A description is given of a variant example of the second example embodiment with reference to FIG. 19, in which an explanation of the same parts of FIG. 17 is omitted. Different from the contact detection system 700 of the second example embodiment (FIG. 17), a contact detection system 700a of the variant example (FIG. 19) includes the input mode switching unit 712 provided with an input-detection ON/OFF signal receiver 721.

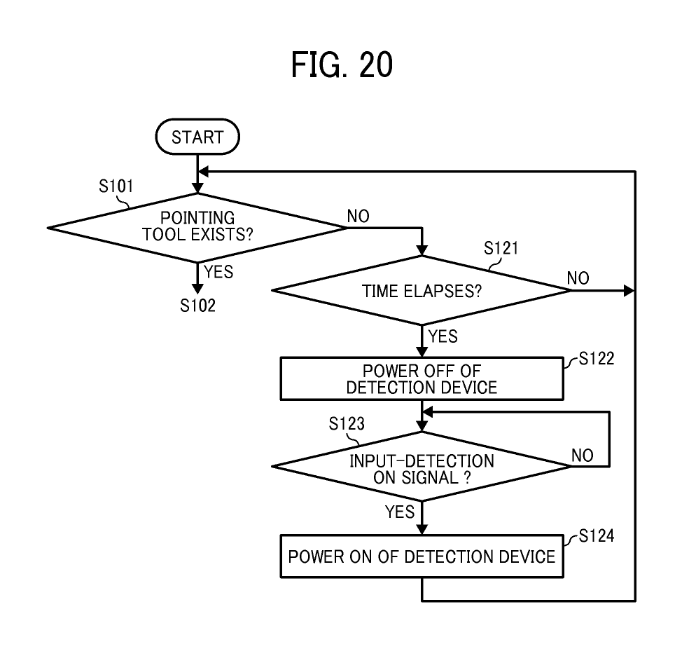

The input-detection ON/OFF signal receiver 721 receives an input-detection ON signal and an input-detection OFF signal. As illustrated in FIG. 20, when the detector 701 determines that the pointing tool 705 is not detected for a given time or more (step S121: YES), the input-detection ON/OFF signal receiver 721 controls the input mode switching unit 712 to shut down power supply to one or more object detection devices such as the detector 701 and the lighting unit 702 (step S122), with which power consumption of each of the object detection devices can be reduced. When the input-detection ON signal is received again (step S123), power supply to the object detection device is resumed (step S124).

Further, in the variant example, power supply to both of the detector 701 and the lighting unit 702 can be turned off, or power supply to one of the detector 701 and the lighting unit 702 can be turned off. When the power supply to both of the detector 701 and the lighting unit 702 is shutdown, power consumption can be reduced greatly compared to when the power supply to one of the detector 701 and the lighting unit 702 is shutdown. As to a configuration that the power supply to both of the detector 701 and the lighting unit 702 is shutdown, it is preferable that the input-detection ON/OFF signal receiver 721 can receive a touching and untouching signal of the light pen on the display 703 from a wireless transmitter disposed in the light pen.

Further, a wireless signal transmitter/receiver of the light pen can use ID signals of a plurality of pens and writing pressure signals as a reception of the input-detection ON/OFF signal. Further, as to the input-detection ON/OFF signal, when a given time elapses without an input operation by the pointing tool 705, the input-detection ON/OFF signal receiver 721 can determine that the input-detection OFF signal is received.

Further, a manual switch signal and a wireless signal from a remote controller can be used as the input-detection ON/OFF signal. With this configuration, the input mode switching unit 712 can receive the input-detection ON/OFF signal.

Further, the light emission unit 1 of the light pen 13 is configured to emit light always in the first example embodiment, but not limited hereto. For example, the light pen 13 can be configured to turn off the light (first light) when a given time (hereinafter, time-out time) elapses after the contact detection unit 2 of the light pen 13 detects the untouching, and turn on the light (first light) again when detecting the touching of the light pen 13 again. This configuration can extend life time of a battery if the light pen 13 is powered by the battery.

If the light pen having the above described light-OFF function is employed, upon receiving the pen-touching event during the finger detection mode, the operation mode transits to the pen detection mode, in which the transition from the finger detection mode to the pen detection mode may be delayed similar to the delay time of conventional systems shown in FIG. 21. However, by setting the time-out time with a greater value such as five seconds or more, response-delay can be prevented even if the light pen 13 having the above described light-OFF function is employed. For example, when a user writes characters by operating the light pen 13, time from the untouching to the next touching of the light pen 13 is smaller than the time-out time, and thereby the delay time can be reduced except at the very beginning of writing of the first character by the user.

The above described contact detection system can detect an input operation by an input device and also an input operation by using a part of human body such as a finger, and the input operation by the input device can be conducted smoothly.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a flexible disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), secure digital (SD) card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A contact detection system comprising:
a display to display an image;
an object detection unit disposed at periphery of the display to detect a contact of an object on the display;
a device detector to detect a first light emitted from an end of an input device to detect a contact of the input device on the display; and
an information processing apparatus connectable to the display, the object detection unit, and the device detector via a network,
wherein the object detection unit including:
a light source to emit a second light to an object;
the device detector including:
an image capturing device to capture an image using the first light emitted from the input device or using the second light emitted from the light source; and
the information processing apparatus including:
an image acquisition unit to acquire an image captured by the image capturing device; and
a control unit to control the light source to turn off the second light when a luminance-increased area caused by the first light exists in the image captured by using the first light and the second light and acquired by the image acquisition unit, and then the control unit to control the device detector to be ready to detect a contact of the input device to the display.

2. The contact detection system of claim 1, wherein the information processing apparatus further includes a drawing unit to draw an image on the display, and
when a luminance-decreased area caused by a portion blocked by an object exists in the image captured by using the second light and acquired by the image acquisition unit, the control unit calculates coordinates of a position of the object detected by the object detection unit that the object is contacting the display, and the control unit controls the drawing unit to start drawing from the calculated coordinate position of the detected object.

3. The contact detection system of claim 1, wherein the information processing apparatus further includes a memory to store coordinate data of a position of the input device on the display,
when a luminance-increased area caused by the first light exists in the image captured by using the first light and the second light and acquired by the image acquisition unit, the control unit calculates coordinates of a position of the input device detected by the device detector that the input device contacts the display, and the control unit controls the memory to store coordinate data of the calculated coordinates of the position of the input device.

4. The contact detection system of claim 3, wherein the information processing apparatus further includes a signal receiver to receive a touching signal and a untouching signal transmittable from the input device, and the control unit controls the drawing unit to start the drawing from the coordinates of the position of the input device identified by the coordinates data stored in the memory when the signal receiver receives the touching signal.

5. The contact detection system of claim 4, wherein the control unit controls the object detection unit to be ready to detect a contact of the object when the signal receiver receives the untouching signal.

6. A method of processing information for a system including a display to display an image, an object detection unit disposed at periphery of the display to detect a contact of an object on the display, a device detector to detect first light emitted from an end of an input device to detect a contact of the input device on the display; and an information processing apparatus connectable to the display, the object detection unit, and the device detector via a network, the method controllable by the information processing apparatus comprising the steps of:
emitting second light to an object from a light source included in the object detection unit;
capturing an image using the first light emitted from the input device or the second light emitted from the light source,
storing the image captured by the image capturing device in a memory;
controlling the light source to turn off the second light when a luminance-increased area caused by the first light exists in the image captured by using the first light and the second light; and
controlling the device detector to be ready to detect a contact of the input device to the display.

7. The information processing method of claim 6, further comprising the steps of
detecting a position of the object contacting the display when a luminance-decreased area caused by a portion blocked by the object exists in the image captured by using the second light;
calculating coordinates of the position of the object detected by the detecting step;
storing the calculated coordinates of the position of the object in the memory; and
drawing an image on the display from the calculated coordinates of the position of the object.

8. The information processing method of claim 6, further comprising the step of
detecting a position of the input device contacting the display when the luminance-increased area caused by the first light exists in the image captured by using the first light and the second light;
calculating coordinates of the position of the input device on the display;
storing the calculated coordinates of the position of the input device on the display in the memory as coordinate data

9. The information processing method of claim 8, further comprising the step of
receiving a touching signal or a untouching signal transmittable from the input device; and
controlling the drawing unit to draw an image from the coordinates of the position of the input device identified by the coordinate data stored in the memory when the touching signal is received.

10. The information processing method of claim 9, further comprising the step of
controlling the object detection unit to be ready to detect a contact of the object when the untouching signal is received.

11. An information processing apparatus connectable to a display to display an image, an object detection unit disposed at periphery of the display to detect a contact of an object on the display, the object detection unit including a light source, and a device detector to detect first light emitted from an end of an input device to detect a contact of the input device on the display, the device detector including an image capturing device, in which the information processing apparatus, the display, the object detection unit, and the device detector connectable one to another via a network, the information processing apparatus comprising;
an image acquisition unit to acquire an image captured by the image capturing device by using the first light emitted from the input device or an image captured by the image capturing device by using second light emitted from the light source; and
a control unit to control the light source to turn off the second light when a luminance-increased area caused by the first light exists in the captured image and acquired by the image acquisition unit, and then to control the device detector to be ready to detect a contact of the input device to the display.

12. The information processing apparatus of claim 11, further comprising
a drawing unit to draw an image on the display,
wherein when a luminance-decreased area caused by a portion blocked by the object exists in the image captured by using the second light and acquired by the image acquisition unit, the control unit calculates coordinates of a position of the object detected by the object detection unit that the object contacts the display, and the control unit controls the drawing unit to start drawing from the calculated coordinates of the position of the object.

13. The information processing apparatus of claim 11, further comprising
a memory to store coordinate data of a position of the input device on the display,
wherein when a luminance-increased area caused by the first light exists in the image captured by using the first light and the second light and acquired by the image acquisition unit, the control unit calculates coordinates of a position of the input device when the device detector detects a contact of the input device on the display, and the control unit controls the memory to store the calculated coordinates of the position of the input device as coordinate data.

14. The information processing apparatus of claim 13, further comprising
a signal receiver to receive a touching signal and a untouching signal transmittable from the input device, and
wherein the control unit controls the drawing unit to start drawing from the coordinates of the position of the input device identified by the coordinate data stored in the memory when the signal receiver receives the touching signal.

15. The information processing apparatus of claim 14, wherein the control unit controls the object detection unit to be ready to detect a contact of the object when the signal receiver receives the untouching signal.
